(19) United States
(12) Patent Application Publication
(10) Pub. No.: US 2013/0085615 A1
(43) Pub. Date: Apr. 4, 2013

(54) SYSTEM AND DEVICE FOR PATIENT ROOM ENVIRONMENTAL CONTROL AND METHOD OF CONTROLLING ENVIRONMENTAL CONDITIONS IN A PATIENT ROOM

(71) Applicant: Kimberly Ann Barker, Palatine, IL (US)

(72) Inventor: Kimberly Ann Barker, Palatine, IL (US)

(73) Assignee: Siemens Industry, Inc., Alpharetta, GA (US)

(21) Appl. No.: 13/398,593

(22) Filed: Feb. 16, 2012

Related U.S. Application Data
(60) Provisional application No. 61/541,653, filed on Sep. 30, 2011.

(51) Int. Cl. G05D 23/19; G05B 15/02

(52) U.S. Cl. 700/277; 700/275

(57) ABSTRACT

A patient environmental control system, device and method are disclosed. The exemplary method includes detecting a state event representative of an environmental condition within the patient room, and generating, in response to the state event, a data packet containing a payload and formatted according to a first protocol and where the payload includes environmental control information, communicating the data packet to a field panel such that the field panel is in communication with a first building automation system and a second building automation system, adjusting a first environmental control parameter related to the first building automation system based on the environmental control information contained within the received payload, and adjusting a second environmental control parameter related to the second building automation system based on the environmental control information contained within the received payload such that the second environmental control parameter is different than the first environmental control parameter.

### CLAIM FOR PRIORITY

This patent document claims the priority benefit under 35 U.S.C. §119(e) of U.S. provisional patent application serial No. 61/541,653 (2011P01756US), filed on Sep. 30, 2011, the content of which is hereby incorporated by reference to the extent allowed by law.

### TECHNICAL FIELD

This patent document generally relates environmental control systems, and more particularly to a patient room environmental control system and device configured to provide a patient or other individual with direct control over the environmental systems and properties within a patient room.

### BACKGROUND

Hospitals, nursing homes and outpatient facilities in general, and patient rooms in particular, are designed and configured to strike a balance between medical care, patient comfort and efficient operation. Guidelines such as ASHRAE Advanced Engineering Guide for Small Hospitals and Healthcare Facilities; LEED 2009 for Healthcare EQ Credit 6.1, Controllability of Systems: Lighting and EQ Credit 6.2, Controllability of Systems: Thermal Comfort; and FGI 2006, AIA 2006, 2.1-10.3.5.2 are intended to help these facilities provide the best possible environment for patients while maximizing the ability to provide medical care and operate in an efficient manner.

These guidelines provide and recommend that occupant controls in private rooms be readily accessible from the patient's bed and allow for control of the exterior window shades, blinds and/or curtains. Moreover, these guidelines recommend that patient rooms provide individual thermal comfort controls for each patient and/or patient room.

### SUMMARY

The disclosed system and device for patient room environmental control and the method of controlling environmental condition in a patient room provide detailed examples of how required features and functionalities can be implemented and provided in a hospital environment. Moreover, the disclosed system and device may be utilized in conjunction with a building automation control system and/or environmental control system in order to optimize energy performance for the structure. For example, a daylight or ambient light sensor may be deployed in each patient's room and may operate in conjunction with one or more shade and/or lighting controls in order to maximize or harvest available lighting to reduce energy costs associated with lighting and environmental controls. Moreover, an environmental control routine and more specifically a lighting control subroutine may be configured to selectively control the intensity and output of the lighting devices deployed within a patient's room in order to maintain a constant level of illumination. In other words, as the ambient light level within a patient's room varies throughout the course the day, the intensity and output of individual lighting devices may be varied to compensate for or otherwise complement the ambient lighting detected within the given area.

In one embodiment, a patient room interface is disclosed. The patient room interface includes a processor, and a memory in communication with the processor and configured to store processor-executable instructions. The processor-executable instructions are configured to detect a state event associated with an environmental condition within the patient room, and communicate, in response to the detected state event, a data packet containing a payload that includes environmental control information related to a first building automation system and a second building automation system, and independently adjust, in response to the environmental control information, a first environmental control parameter related to the first building automation system and a second environmental control parameter related to the second building automation system, wherein the second environmental control parameter is different than the first environmental control parameter.

In another embodiment, a patient room environmental control system is disclosed. The system includes a patient room interface having a processor and a memory configured to store processor-executable instructions. The instructions are arranged to detect a state event representative of an environmental condition within the patient room, and generate, in response to the state event, a data packet containing a payload, wherein the data packet is formatted according to a first protocol and wherein the payload includes environmental control information. The system further includes a building automation controller in communication with the patient room interface via a building automation network. The controller, in turn, is configured to receive the data packet formatted according to the first protocol, generate an environmental control communication according to a second protocol, wherein the environmental control communication includes the environmental control information, communicate the environmental control communication to an automation device operating according to the second protocol, and adjust the automation device based on the environmental control communication and the environmental control information to change the environmental condition.

In another embodiment, a method of environmental control within a patient room is disclosed. The method includes the steps and processes of detecting a state event representative of an environmental condition within the patient room, generating, in response to the state event, a data packet containing a payload such that the data packet is formatted according to a first protocol and wherein the payload includes environmental control information, communicating the data packet to a field panel such that the field panel is in communication with a first building automation system and a second building automation system, adjusting a first environmental control parameter related to the first building automation system based on the environmental control information contained within the received payload, and adjusting a second environmental control parameter related to the second building automation system based on the environmental control information contained within the received payload wherein the second environmental control parameter is different than the first environmental control parameter.

Other embodiments, configurations, modifications and variations of these summarized concepts are disclosed, and each of the disclosed embodiments can be used alone or together in combination. Additional features and advantages of the disclosed embodiments are described in, and will be apparent from, the following Detailed Description and the figures.

### BRIEF DESCRIPTION OF THE FIGURES

FIG. 1 illustrates an exemplary patient room configuration that utilizes and a unified patient room interface and implements the controls as disclosed herein;

FIG. 2 illustrates a functional block diagram of the exemplary unified patient room interface shown in FIG. 1

FIG. 3A depicts a logical block diagram of an exemplary control program that may be implemented by the controller of the exemplary unified patient room interface;

FIG. 3B depicts an example of SOAP communication that may be generated by a SOAP interface routine portion of the control program of FIG. 3A;

FIG. 4 illustrates an exemplary user interface that may be presented by the unified patient room interface of FIG. 2;

FIG. 5 is a flowchart representing one operational embodiment of the control program that may be implemented in accordance with the teaching disclosed herein;

FIG. 6 illustrates another exemplary user interface that may be presented by the unified patient room interface of FIG. 2; and

FIG. 7 illustrates another exemplary user interface that may be presented by the unified patient room interface of FIG. 2.

### DETAILED DESCRIPTION

The disclosed system and device for patient room environmental interface and control as well as the method of controlling environmental condition in a patient room provide detailed examples of how these advantageous features and functionalities can be implemented and provided in a hospital environment. Moreover, the disclosed system and device may be utilized in conjunction with a building automation control system and/or environmental control system in order to optimize energy performance for the structure. For example, a daylight or ambient light sensor may be deployed in each patient's room and may operate in conjunction with one or more window shade and/or lighting controls in order to maximize or harvest available lighting to reduce energy costs associated with lighting and environmental controls. Alternatively, or in addition, an environmental control routine and more specifically a lighting control routine may be configured to selectively control the intensity and output of the lighting devices deployed within a patient's room and operate one or more window shade controls in order to maintain a constant level of illumination. Thus, as the ambient natural light level within a patient's room varies throughout the course the day, the intensity and output of individual artificial lighting devices may be varied to compensate for or otherwise maintain overall lighting level within the patient room or any other given area.

In other embodiments, the disclosed system and device may be integrated with the environmental control system operable within both the patient room and the overall hospital structure. For example, in one integrated embodiment the patient may be empowered to control the room temperature, perform lighting adjustments as well as vary the position of the window shades without requiring intervention of hospital staff or leaving the safety and comfort of the patient bed. In this way, the patient's needs and comforts may be satisfied without incurring risk to themselves or otherwise utilizing the hospital staff to perform nonmedical or healthcare related tasks. The integrated embodiment therefore empowers both the patient and frees hospital staff and other personnel to pursue more efficient uses of their time.

In another integrated embodiment, the disclosed system and device may be utilized to control individual heating, ventilation and air conditioning (HVAC) units deployed and arranged to control the environment within an individual patient room. In this way, each patient room may be adjusted to provide a customized HVAC and lighting solution specific to each patient's comfort level. Moreover, the disclosed system and device may be preconfigured with one or more system settings to provide, for example, maximum lighting conditions in which to perform procedures, in case of emergencies, or another setting to provide a relaxing ambient environment or other desired condition or event.

The embodiments discussed herein include environmental control devices, building automation devices and wireless automation devices incorporating or communication with a transceiver. The embodiments may include BACNet, IEEE 802.15.4/ZigBee-compliant devices and components such as, for example, one or more personal area network (PAN) coordinators implemented as a field panel (FPX or PXC); a full function device (FFD) implemented as a floor level device transceiver (FLNX); and a reduced function device (RFD) implemented as a wireless room temperature sensor (WRTS). Regardless of the specific type and functionality of any given device or component, compliance with recognized building control and automation standards such as BACNet and/or ZigBee standards ensure communication and interoperability with the building automation network and system deployed within the structure. The devices and components identified herein are provided as an example of environmental control devices, building automation components, wireless devices and transceivers that may be integrated and utilized within structure but are not intended to limit the type, functionality and interoperability of the devices and teaching discussed and claimed herein.

### I. Patient Room Configuration

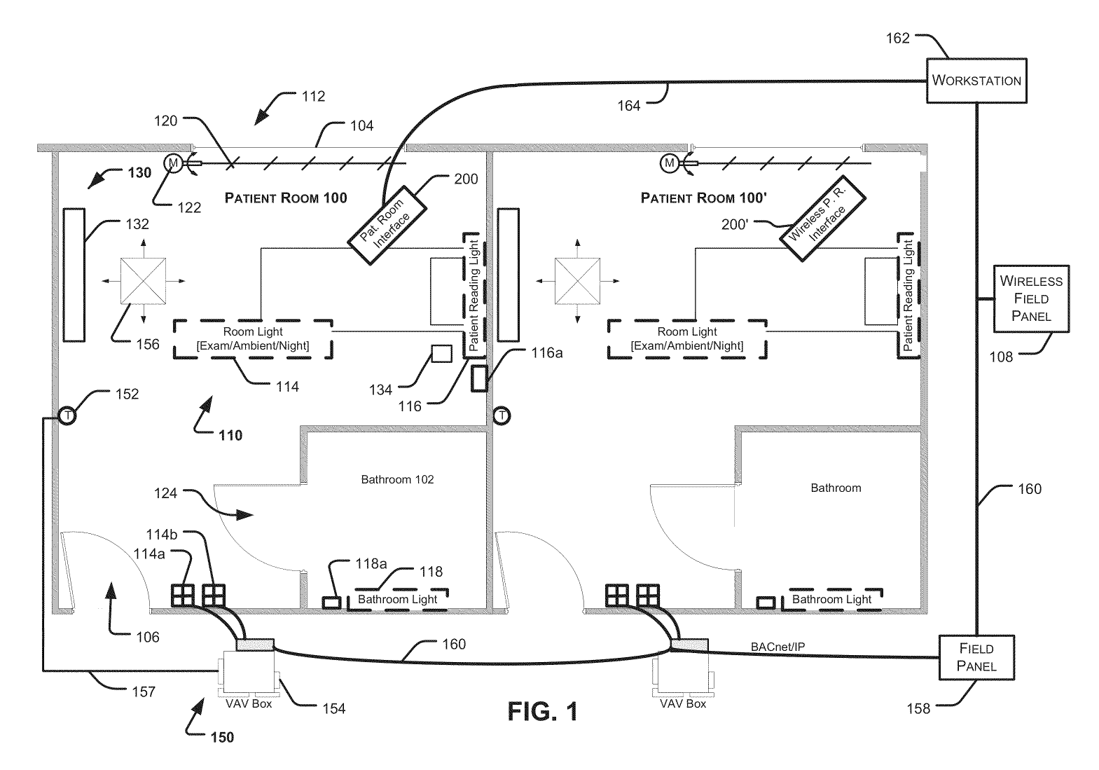

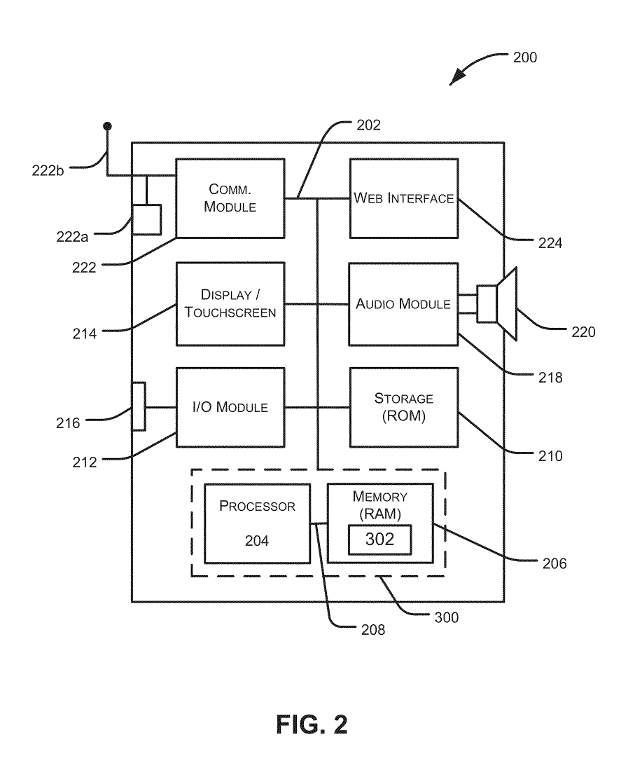

FIG. 1 depicts an exemplary patient rooms 100 and 100′ that may be coupled to a unified patient room interface 200 and a unified patient room interface 200′ (see FIG. 2). In this embodiment, the patient rooms 100 and 100′ are substantially the same configuration and include substantially the same elements and devices. However, the unified patient room interface 200 of the patient room 100 is a wired device, while the unified patient room interface 200′ of the patient room 100′ is a wireless device. For the sake of convenience, the description and discussion provided herein focuses on the patient room 100. It should be understood that the principles set forth herein are equally applicable to both the wired and wireless configurations of the unified patient room interface 200.

The exemplary patient room 100 includes and incorporates a room lighting system 110, an integrated entertainment system 130 and an environmental control system 150. These systems may be provided by different manufactures and operate according to different standards and control protocols. In one exemplary configuration, the room lighting system 110 may be a multi-grouped and multi-zoned system configured to holistically control the illumination within the patient room 100 as well as an attached bathroom 102. For example, the room lighting system 110 may incorporate a first lighting group to control ambient light levels using a window shade control system 112. The room lighting system 110 may further incorporate a second lighting group to control the artificial lighting devices deployed within the patient room 100. The second lighting group may include an overhead examination light 114 and a patient reading light 116 and a bathroom light 118. The overhead examination light 114 and the patient reading light 116 may cooperate to define a first lighting zone within a main portion of the patient room 100 while the bathroom light 118 may define a second lighting zone within the bathroom 102.

The window shade control system 112, in this exemplary embodiment, mounts to and/or is carried by the frame of a room window 104 constructed into an exterior wall of the patient room 100. The window shade control system 112 may include a shade or a plurality of shades 120 coupled to a positioning motor 122. The positioning motor 122 may be configured to raise or lower the shade or rotate the plurality of shades 120 to thereby adjust the ambient light allowed into the patient room 100 through the window 104.

The room lighting system 110 may be configured to allow for manual control of each of the lights 114, 116 and 118 using a corresponding wall switch 114a, 116a, and 118a. Each wall switch may be mounted at an accessible location for an intended user. For example, the wall switch 114a controls the overhead examination light 114 and may be mounted adjacent to the room door 106 for easy access by doctors, nurses, housekeeping staff and visitors as they enter the patient room 100. In one embodiment, the wall switch 114a may include or communicate with a light sensor 114b. The light sensor 114b may be a photo-sensor configured to detect the ambient lighting within the patient room 100. Another wall switch 116a may be mounted near the patient's bed to provide manual control of the patient reading light 116. Similarly, the wall switch 118a may be mounted near the bathroom door 124 to allow for manual control of the bathroom light 118 within the bathroom 102. In another embodiment, the wall switch 118a may include a motion sensor (not shown) configured to automatically activate the bathroom light 118 when the patient or other person enters the bathroom 102.

The patient room 100 further includes the integrated entertainment system 130 to control and communicate with entertainment and/or communications equipment available to the patient. The integrated entertainment system 130 may include, for example, a television or monitor 132, a telephone or telecom system 134, a music system (not shown), a gaming console (not shown) or any other known or later developed entertainment device. The integrated entertainment system 130 may further control and connect with a local area network, a personal area network, a router, a network addressable storage device or other computing equipment. In another embodiment, the integrated entertainment system 130 may provide or act as a communication gateway for one or more cellular devices.

The environmental control system 150 may be designed and configured to control the room temperature and other air conditions or variables within the patient room 100. The environmental control system 150 may include a sensor 152 that may be configured to detect, for example, temperature; carbon monoxide; carbon dioxide; humidity and generate a sensor signal representative of the detected condition. The environmental control system 150 may further include or communicate with an HVAC unit 154. The HVAC unit 154 may be a water-source heat pump, a fan coil or a variable air volume (VAV) terminal unit such as a Zone Control Unit (ZCU) manufactured by Siemens Industry, Inc., Building Technologies Division (hereinafter referred to as “Siemens”). In one embodiment, the environmental control system 150 may provide direct or indirect control over the airflow delivered by the VAV terminal unit in order to allow the temperature and humidity conditions within the patient room 100 to be adjusted. By interacting with and directing the airflow generated by an exemplary VAV terminal unit, the airflow volume delivered through the vent 156 may be adjusted. In other embodiments, the HVAC unit 154 may be controlled to change the temperature of the airflow delivered via the vent 156.

The automation devices and systems of the room lighting system 110, the integrated entertainment system 130 and the environmental control system 150 may, in one embodiment, be hardwired to a typical 120V/240V power source that supplies the patient room 100. Similarly, the automation devices and system may utilize existing network and infrastructure wiring to communicate information. For example, the sensor 152 may communicate temperature information or data to the HVAC unit 154 via a wired connection 157. This information and data may, in turn, be communicated to an APOGEE® field panel (FPX or PXC) 158 and/or a building automation workstation 162 via a building automation network 160. In this embodiment, the building automation workstation 162 may be an INSIGHT® building automation workstation and the building automation network 160 may be a compatible BACnet/IP network both of which are manufactured and provided by Siemens.

Alternatively, or in addition to, the devices and systems may employ wireless technology such as, for example, IEEE 802.11 (Wi-Fi), IEEE 802.16 (WiMAX), IEEE 802.20 (wireless broadband), IEEE 802.15.4 (ZigBee) or any other known or later developed wireless standard or protocol. In this embodiment, the patient room 100 may include a wireless field panel 108 (FLNX) configured to wirelessly receive information, data or signals from the devices or systems operable within the room lighting system 110, the integrated entertainment system 130 and the environmental control system 150. For example, information and data from the sensor 152 may be wireless communicated to the wireless field panel (FLNX) 108 for communication to a field panel 158 such as an APOGEE® field panel (FPX or PXC) and/or the HVAC unit 154. The received information or data may retransmitted or otherwise provided to the building automation workstation 162 via the building automation network 160.

The building automation workstation 162, and more particularly the INSIGHT® application operable on the building automation workstation 162, is configured to collect and analyze information and data related to the patient room 100 from one or more automation devices deployed therein. Specifically, the INSIGHT® application is configured to utilize the received information to monitor and control the automation devices or systems operable within the room lighting system 110, the integrated entertainment system 130 and the environmental control system 150 according to one or more control routines or processes. The control routines and processes may be designed to optimize the environmental controls and power usage through the structure controlled and monitored by the building automation system. The operation of the control routines and processes can further allow for manual control of one or more devices via manual controls and switches 114a, 116a and 118a disbursed throughout the patient room 100. Control or interaction with elements of the room lighting system 110, the integrated entertainment system 130 and the environmental control system 150 further realized via a wireless connection established between the unified patient room interface 200′ and the building automation workstation 162. In another embodiment, the unified patient room interface 200 may be connected to the building automation workstation 162 via a wired connection 164.

### II. Unified Patient Room Environmental Control Device and Interface

FIG. 2 illustrates an internal block diagram of the unified patient room interface 200 that may be coupled to or in communication with the automation devices and systems within the patient room 100. In particular, the unified patient room interface 200 includes both the hardware of a patient control device and the controls that generate a user interface by which a patient can affect environmental control over the patient room 100 from a central location. For example, the disclosed patient control device is a bedside device configured to allow a patient to autonomously control one or more environmental conditions within the patient room 100. This autonomous control empowers the patient without increasing their risk of injury by requiring them to leave their bed to adjust and control the environmental conditions. By providing a patient with a means of effecting control over the environmental conditions (i.e., the lighting, the air temperature and/or airflow, and the entertainment and communication systems) within the patient room 100, the patient room interface 200 frees hospital personnel from having to perform these mundane tasks while at the same time empowering the patient at a time when they may normally feel powerless and vulnerable.

The internal block diagram representing the configuration of the unified patient room interface 200 illustrates individual functions and/or modules as separate logical entities in communication via a bus 202. These logical entities may represent individual physical components that may be assembled as a part of a printed circuit board (PCB). Alternatively, these functions and modules may be integrated into a single or limited number of physical components. These functions and modules may each represent a specialized computer program or processor-executable code configured to gather, process or otherwise manipulate patient commands and data to control or operate the automation devices or systems of the room lighting system 110, the integrated entertainment system 130 and the environmental control system 150.

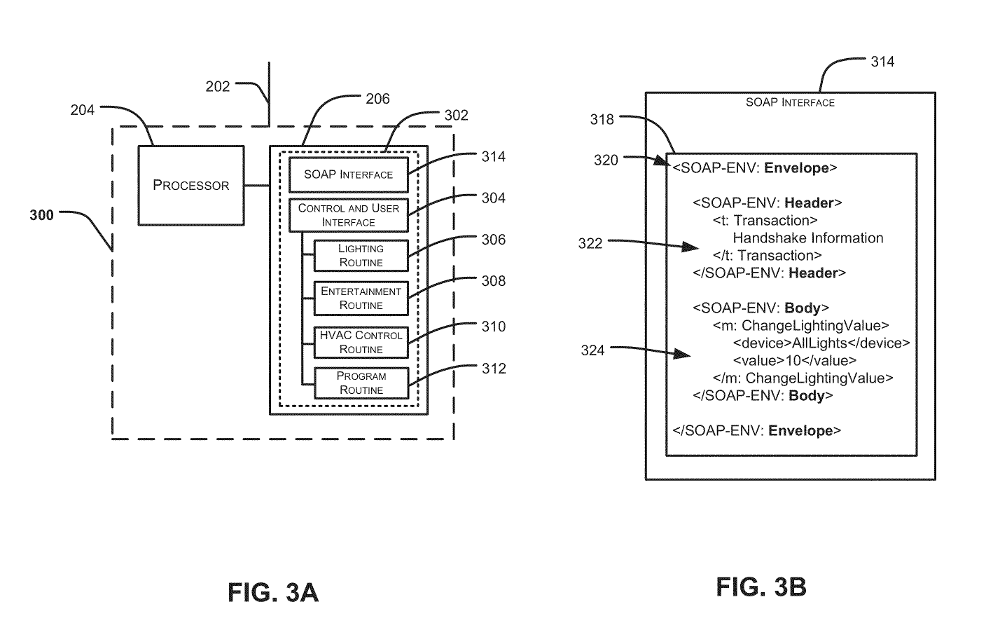

The unified patient room interface 200 may include the controller 300 (see FIG. 3A) comprising a processor 204 and a memory 206. In one embodiment or configuration, the processor 204 may be a computer processor configured to receive commands or instructions from the user for communication to the building automation workstation 162 in order to control one or more of the automation devices or systems of the room lighting system 110, the integrated entertainment system 130 and the environmental control system 150. The memory 206 may be volatile memory such as random access memory (RAM), static RAM (SRAM), dynamic RAM (DRAM) or any other memory accessible by the processor 204. The memory 206 may operate as a register, cache and virtual memory or swap space for the processor 204. In this embodiment, the memory 206 stores a control routine 302 (see FIG. 3A) for access and execution by the processor 202.

Alternatively, the controller 300 may be a single application-specific integrated circuit (ASIC) programmed and or customized to control and direct the operations of unified patient room interface 200. An exemplary ASIC may include an entire 32 or 64-bit processor, memory blocks including, but not limited to, read only memory (ROM), random access memory (RAM), electrically erasable programmable read-only memory (EEPROM), and flash memory. The ASIC could be utilized to replace the combination of the processor 204 and memory 206 within the exemplary controller 300.

In the present embodiment, the memory 206 and the processor 204 are arranged and configured to directly communicate with each other via a communication channel or dedicated bus 208. In another embodiment and configuration, the memory 206 may be shown to be in communication with the processor 204 via the bus 202. In this way, the processor 204 and the program module 206 may be maintained as separate and distinct devices within the unified patient room interface 200.

The controller 300 may be coupled to and in communication with a secondary memory or storage module 210 via the bus 202. In the present embodiment, the storage module 210 is illustrated as a separate element from the controller 300. However, in other embodiments the storage module 210 may be an integral part of the controller 300. The storage module 210 maybe any known or later developed computer readable medium and/or nonvolatile storage device such as, but not limited to, a hard drive, a solid-state drive (SSD), flash ROM (read-only memory) or an optical drive. The storage module 210 may be configured to accessibly store the information, data and executable files necessary to provide the desired functionality associated with the unified patient room interface 200. For example, the storage module 210 may store the operating system, programs, and executable algorithms utilized by the controller 300.

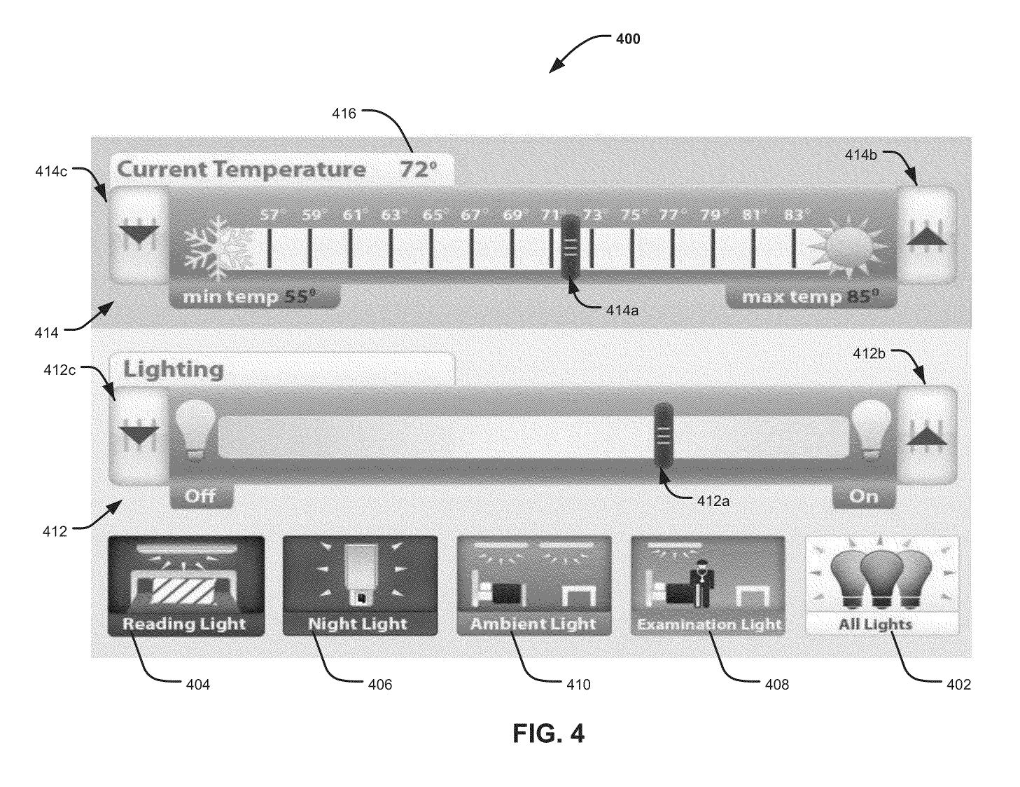

In operation, the processor 204 may communicate with and access information on the storage module 210 via the bus 202. For example, in order to generate a graphical user interface (GUI) or user interface 400 (see FIGS. 4A to 4C), the processor 204 may access an appropriate subroutine stored in the storage module 210 and executable from within the memory 206. The information necessary to generate the user interface 400 may, in turn, be communicated via the bus 202 to a display and/or touchscreen 214. The touchscreen 214 may be configured to receive information, selections and/or commands provided via a resistive or capacitive input layer (not shown) responsive to a user interaction. The touchscreen 214 provides an integrated mechanism by which the user interface 400 may be presented to a user. An I/O module 212 may augment and/or cooperate with the touchscreen 214 to process and translate information received via keyboard (not shown), a mouse or trackball (not shown) or to present information via a simple monitor or display.

The I/O module 212 may further include one or more inputs 216. The one or more inputs 216 may be, for example, a secure digital (SD) card reader that augments or expands the capability of the storage module 210. Alternatively, or in addition to, an SD card (not shown) and the secure digital card reader may be utilized to transfer or update information, algorithms and programs contained within the storage module 210 for execution by the controller 300. The inputs 216 may, in another embodiment, be a connector or dock for a digital music player such as an iPod® or Zune® from Apple, Inc. or Microsoft Corp., respectively. In yet another embodiment, the input 216 may be a universal serial bus (USB) connector, a digital video interface (DVI) connector, a serial port connector or any other known or later conceived connection for communicating information between devices.

The unified patient room interface 200 may further include an audio module 218 in communication with the controller 300 via the bus 202. The audio module 218 may be configured to convert a digital sound file such as an MP3 or way file into an analog signal that maybe broadcast or played via a speaker 220. In one embodiment, the input 216 may connect to a digital music player (not shown) to allow the digitally stored music contained thereon to be converted or played by the audio module 218 and broadcast via the speaker 220. In yet another embodiment, the processor 204 may communicate or play music or other audio information via the integrated entertainment system 130 and the audio module 218.

A communication module 222 provides both wired or wireless communication capabilities that allow for communication with one or more of the automation devices or systems within the patient room 100. For example, the communication module 222 can allow the unified patient room interface 200 to exchange information with the room lighting system 110, the integrated entertainment system 130 and the environmental control system 150 by way of the building automation workstation 162. In one embodiment, information or commands received via the touchscreen 214 may be processed by the controller 300 and communicated to the building automation workstation 162 via the wired connection 164 established with the communication module 222. The building automation workstation 162, in turn, transmits the information via the building automation network 160 to the wireless field panel (FLNX) 108 and/or the field panel 158. The field panels 108, 158 may then provide the information, in either a wired or wireless manner as appropriate, to one or more of the automation devices operable within the room lighting system 110, the integrated entertainment system 130 and the environmental control system 150. The communication module 222 can, in turn, receive information in the same manner discussed above. The received information may be presented via the touchscreen 214, stored within the storage model 210 and/or used by the controller 300 as an input in one or more routines or software discussed herein.

The communication module 222 may be configured to communicate via a powerline network, an Ethernet network, a two-wire network or other known networking configuration via a communications port 222a. In another embodiment, the communication module 222 may be configured to communicate according to IEEE 802.11 (Wi-Fi), IEEE 802.16 (WiMAX), IEEE 802.20 (wireless broadband), IEEE 802.15.4 (ZigBee), Bluetooth, or other known radio communications protocol, via a wireless transceiver 222b. The communications module 222 may be configured to operate as a dual mode communication module in order to provide both wired and wireless communications for increased flexibility. Alternatively, or in addition to, the communication module 222, when operating as a dual-mode communication module, may send and receive information according to multiple wireless communication protocols. For example, the communication module 222 may be configured to simultaneously communicate information according to IEEE 802.11 (Wi-Fi) and IEEE 802.15.4 (ZigBee).

In another embodiment, the communication module 222 may cooperate with a web interface 224 to establish an access portal for remotely viewing and/or monitoring information related to the room lighting system 110, the integrated entertainment system 130 and the environmental control system 150. The web interface 224 may, in conjunction with the communication module 222 access the Internet or other network for information or infotainment browsing via the touchscreen or display 214. In yet another embodiment, the web interface 224 provides a mechanism by which the information and capabilities of the unified patient room interface 200 may be accessed or controlled remotely via browser such as Microsoft's Internet Explorer® or Apple's Safari®.

FIG. 3A depicts a functional block diagram representation of the controller 300. In particular, FIG. 3A illustrates the processor 204 in communication with the memory 206 via the bus 208. The memory 206, in the illustrated representation, stores the control routine 302 executable by the processor 204 and configured to direct the operation of the unified patient room interface 200. The control routine 302 may, in turn, include numerous subroutines, software applications and/or modules that when executed by the processor 204 direct the operation of the automation devices or systems operable within the room lighting system 110, the integrated entertainment system 130 and the environmental control system 150.

The control routine 302 may include a control and user interface routine 304 configured to generate the graphical user interface 400 (see FIG. 4) and integrate the functions and operations of a lighting control routine 306, a entertainment control routine 308, an environment and/or HVAC control routine 310 and a stored program routine 312. Each of the routines 306, 308, 310 and 312 control and communicate with the automation devices or systems operable within the room lighting system 110, the integrated entertainment system 130 and the environmental control system 150. These systems, in turn, may operate according to different communication standards and protocols such as DALI, BACnet, LON, KNX and any other know or later developed standards and protocols.

The control routine 302 may be a self-contained program or firmware that includes all the information, functions and libraries necessary for the operation of the unified patient room interface 200. Alternatively, the control routine 302 may utilize one or more application programming interface (API) stored in, for example, the memory 206 to access and utilize information, functions and libraries accessibly stored on the storage module 210. The control routine 302 may further include or access one or more drivers to communicate information and data between, for example, the processor 204, the touchscreen 214, the audio module 218, and the communication module 222.

The control routine 302 further includes simple object access protocol (SOAP) interface 314. The SOAP interface 314 provides a mechanism and means by which the different automation devices using difference communication protocols and standards can exchange information. By using the SOAP interface, an automation device that communicates according to a first protocol can exchange information in the form of data packets with a different automation device that communicates according to a second protocol. The SOAP interface 314 and data packets communicate information between the different automation devices as tag data in an extensible markup language (XML) stream format utilizing hypertext transfer protocol (HTTP). The extensible, text-based framework enables communications between the diverse automation devices without requiring either device to have knowledge of the others communication protocol and/or standard.

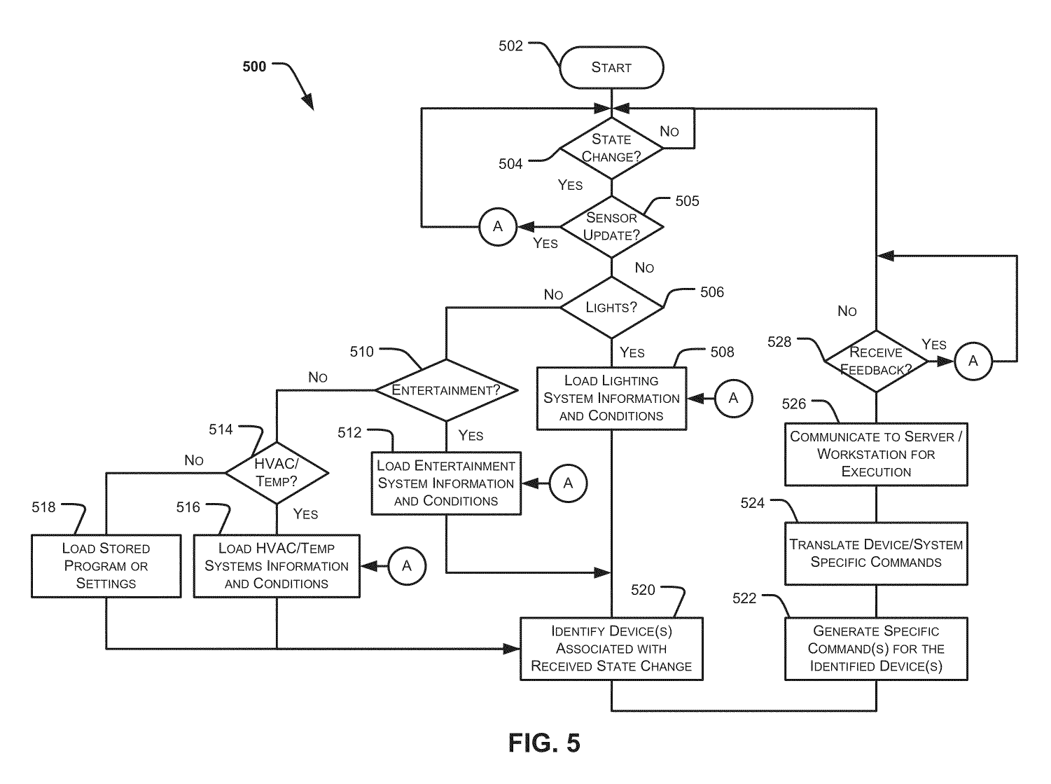

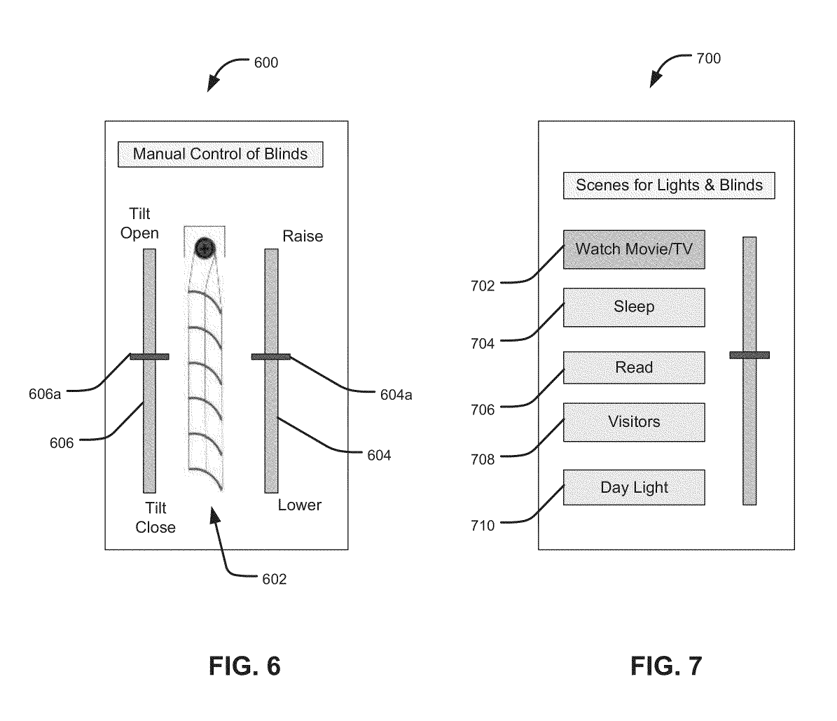

FIG. 5 is a flowchart 500 depicting one example of the operations and functions that may be performed by the control routine 302 when executed by the processor 202. In this embodiment, the control routine 302 activates (i.e., begins implementation of the steps and functions illustrated in the flowchart 500) when the unified patient room interface 200 is connected to and energized by a power supply (step 502). In another configuration, the control routine 302 may be activated in response to a user input provided via, for example, the touchscreen 214 or a power button (not shown). The control routine 302 may remain in an idle state (i.e., a continuous loop) until a change of state or state event associated with an environmental condition within the patient room being monitored is detected (step 504). The environmental condition(s) represented by the change of state or state event can include virtually any user-initiated change or other command that influences or alters the environmental within the patient room 100. For example, the change of state or state event could represent a user command to adjust the temperature and/or airflow provided by the HVAC unit 154. In another embodiment, the state event can reflect a change detected by one or more remote sensing or monitoring devices within the patient room 100. In yet another embodiment, a change of state may occur based on the initiation and/or expiration of a timer or a schedule (i.e., a time of day, day of the week, a seasonal period). State events may be custom programmable conditions defined at, for example, the building automation workstation 162 and/or predefined events and conditions provided by the INSIGHT® building control application executing on the building automation workstation 162.

Upon detection of a change of state or state event, the control routine 302 evaluates the state event to determine if it represents an update to a sensor value or a command to change the operation of one or more automation devices or systems operable within the room lighting system 110, the integrated entertainment system 130 and the environmental control system 150 (step 505). If the control routine 302 determines the state event to be a sensor update, the current state information is overwritten with the new sensor data (see steps 508, 512 and 516) and the control routine 302 returns to an idle state. Once the current state information has been updated, the control routine 302 then returns to an idle state (see step 504). However, if the state event represents a command directed to one or more of the automation devices operating within the patient room 100, the control routine 302 continues processing at steps 506, 510 or 514 based on the received state event.

An example of a state event that causes the control routine 302 to activate (i.e., leave the idle state) may be, for example, the user-selection of an ALL LIGHTS button 402 in FIG. 4 via the user interface 400 presented by the touchscreen 214. The user interface 400, in this exemplary embodiment, may be generated by control and user interface routine 304 operable in connection with the control routine 302. The control routine 302, and more particularly the control and user interface routine 304, analyzes the received selection to determine which routine or system the input pertains. In order to make this determination, the control routine 302 sequentially evaluates the received selection to determine if the selection is related to the lighting routine 306 (see 506), the entertainment routine 308 (see 510), HVAC control routine 310 (see 514) or a stored program routine 312 (see 518). Alternatively, the control routine 302 may analyze a flag or header associated with the received user selection in order to determine which of the routines 304 to 312 should be activated.

In the present example, the user selection of the ALL LIGHTS button 402 results in the activation of the lighting routine 306 portion of the control routine 302 (step 506). The lighting routine 306 may, in this exemplary embodiment, include the information, communication protocols, and values necessary to interact with the automation devices or systems operable within the room lighting system 110. For example, the lighting routine 306 may include the digital addressable lighting interface (DALI) information and commands required to communicate with and control the overhead examination light 114, the patient reading light 116 and the bathroom light 118 positioned within the patient room 100.

Once the lighting routine 306 has been identified and activated by the control routine 302, the current state information may be loaded (step 508) from, for example, the memory 206 and/or the workstation 162. The current state information, in turn, may be provided by, for example, the wireless field panel 108 and the field panel 158 communicating with the lights 114 to 118 and the window shade control system 112. The current state information may include, for example, the last known status for each of the lights 114 to 118, the status of the window shade control system 112 including the current position of the positioning motor 122 and the shades 120, as well as any information about the ambient light condition within the patient room 100 provided by the light sensor 114b. The user may update and adjust the current state information via the user interface 400 thereby causing the control routine 302 and the lighting routine 306 to display the revised information on the touchscreen 214 and/or store the revised information in the memory 206 or storage module 210.

The control routine 302 next determines which of the automation devices and systems operable within the room lighting system 110 are to be modified by the user selection and the lighting routine 306 (step 520). In the present example, receipt of a command or value associated with the ALL LIGHTS button 402 indicates that the each of the lights 114 to 118 are to be activated. The control routine 302 next identifies the specific commands and information for a first protocol, such as DALI protocol, utilized by the room lighting system 110 (step 522). The command, in this example, may indicate that “all lights” within the patient room 100 are to be activated at maximum intensity (e.g., 10 on a scale of 1 to 10.) In another embodiment, receipt of the command or value associated with the ALL LIGHTS button 402 could cause the control routine 302 to alert or otherwise communicate with the building automation workstation 162. In this embodiment, the building automation workstation 162 can, in response to the received command, can direct the wireless field panel 108 or the field panel 150 to identify which of the lights 114 to 118 are to be activated. Similarly, the field panels 108 and 158 may be configured to control the position of the blinds in conjunction with the lights 114 to 118, the time of day and/or the temperature. Regardless of the specific device and or mechanism for controlling each environmental component within the patient room 100, the control routine 302 and the unified patient room interface 200 provide a mechanism by which both the individual environmental element or a group of environmental elements can be controlled and adjusted to satisfy a patient's individual comfort needs and healthcare requirements.

The command generated by the control routine 302 may be communicated to the SOAP interface 314. The SOAP interface 314, in turn, translates the commands and information utilized by the DALI protocol formatted command to generate a platform nonspecific data packet 318 (see FIG. 3B). The data packet or message 318 includes an XML envelope 320 that includes a header 322 and a body 324. The header 322 includes transaction and handshake information necessary to direct the information contained within the data packet 318 and the body 324 to the correct destination. In the present example, the header 322 may collectively or individually identify destination devices as the lights 114 to 118 deployed within the patient room 100. The body 324 contains the payload or commands and information necessary to command and/or control the destination device. For example, the payload may include general and/or device specific environmental control information comprised of a number of individual environmental control parameters. The individual environmental control parameters, in turn, may be utilized by the system as a whole and/or a particular environmental control device in order to achieve or maintain a desired environmental condition within the patient room 100. In one exemplary embodiment, the environmental control parameters contained within the payload portion of the body 324 may include specific device identification information, e.g., the “AllLights” identifier, that corresponds to the initial user selection of the ALL LIGHTS button 402. Alternatively, the environmental control parameters contained within the payload portion of the body 324 may correspond to one or more preprogrammed configurations and scenes that may be implemented and customized by the user. In this way, the environmental control parameters such as the specific device identification information make up the environmental control information that may be communicated and exchanged to adjust a particular device or element within the patient room 100. In another embodiment, the environmental control parameters defined within the environmental control information may include settings, thresholds and values necessary to adjust a number of devices or elements within the patient room 100 according to a pre-defined program or environmental scheme. In this way, the body 324 may include a desired maximum output value or command, e.g., the value of 10, required to turn on all the lights within the patient room 100 when necessary for a patient examination.

Once the data packet 318 has been generated using the information needed to provide a DALI formatted communication to control and exchange information with the automation devices of the room lighting system 110. The data packet 318 may be communicated to the building automation workstation 162 (step 526) over the building automation network 160. The building automation workstation 162 may, in turn, convert the platform nonspecific data packet 318 (i.e., information contained within the XML envelope 320) back to the correct format for use by the lights 114 to 118. The restored or reformatted message and command contained within the data packet 318 can then be communicated by the building automation workstation 162 to the field panel 158 or directly to the lights 114 to 118 via the building automation network 160. Upon receipt of the information within the data packet 318, the light levels of the overhead examination light 114, the patient reading light 116 and the bathroom light 118 can be increased to maximum (e.g., a value of 10) to illuminate the patient room 100 at their highest intensity.

In operation, the data packet 318 may be delivered utilizing the building automation network 160 as a communication medium between, for example, the building automation workstation 162, the field panel 158 and the lights 114 to 118. Alternatively, the data packet 318 may be delivered via a wireless connection utilizing a wireless network established between, for example, the building automation workstation 162 the wireless field panel 108 and the lights 114 to 118. If the room lighting system 110 and/or the individual lights 114 to 118 are configured to provide feedback and/or confirmation that the command has been enacted (step 528), then the received confirmation may be stored in the memory 206 or storage module 210 and/or utilized to update the current state information associated with the lighting routine 302 (see 508). The control routine 300 may return to an idle state until another change of state or state event is detected (see 504).

In other embodiments, the user may interact with the user interface 400 to individually control the lights 114 to 118. For example, by selecting the READING LIGHT button 404 on the interface 400 and adjusting the lighting slider or control 412, the user can change or adjust the brightness of the patient reading light 116. Similarly, by selecting the NIGHT LIGHT button 406 which corresponds to the bathroom light 118 or the EXAMINATION LIGHT button 408 which corresponds to the overheard light 114, the intensity of each can be manually adjusted using the lighting slider 412. For example, by moving the slider 412a left or right, the intensity and brightness of a designated light may be decreased or increased. Alternatively, by selecting the UP lighting button 412b or the DOWN lighting button 412c, the intensity can be incrementally adjusted by a fixed amount (e.g., each increment may correspond to a change of 1 on a 1 to 10 scale.)

In another embodiment, the control routine 302 may detect a change of state or state event that correspond to a detected connection of a media player (not shown) to the input 216 of the unified patient room interface 200 (step 504). Because this change of state impacts the operation of one or more automation devices operating within the patient room 100, the control routine 302 exits the idle state and continues to execute (step 505). The detected state event, in this example, corresponds to the entertainment routine 308 (step 510). Upon determination that the entertainment routine 308 is active, the control routine 302 may load volume and/or connection information associated with the television or monitor 132 (step 512). The control routine 302 can further determine the address and status of the television or monitor 132 associated with the detected change of state (step 520). In this embodiment, the state event corresponding to the connection of the media player to the input 216 may initiate the process of opening an audio channel between devices operable within the integrated entertainment system 130. For example, in response to the detected connection of the media player, the control routine 302 may detect and activate the audio module 218 and the attached speaker 220 of the unified patient room interface 200 as well as the speakers integral to the television or monitor 132.

The control routine 302 may generate or identify a specific command to establish an open communication channel according to any applicable protocol utilized by the integrated entertainment system 130 (step 522). This command or commands may provide for the digital music files or other digital media files stored on the media player to be streamed to the television 132 and the associated audio to be broadcast through the speaker 220 as well as the speakers integral to the television 132. As previously discussed, the command generated by the control routine 302 to open the channel may be communicated to the SOAP interface 314. The SOAP interface 314, in turn, converts (step 524) the original command into an XML data packet 318 (see FIG. 3B) for communication to the building automation workstation 162 (step 526). The building automation workstation 162, in turn, converts the XML data packet 318 and the command back to the correct format for use by the integrated entertainment system 130. The building automation workstation 162 may utilize the building automation network 160 to deliver the command the specified devices (i.e., the television 132 in this example) within the integrated entertainment system 130. Once the command generated by the control routine 302 has been communicated to the appropriate devices of the integrated entertainment system 130, the communication channel may be established and the media and/or audio files stored on the media player may be streamed throughout the patient room 100. If acknowledgement of the communication channel is provided (step 528), the current state information associated with the entertainment routine 308 (see 512). Upon completion of the update, or if is no update is performed, the control routine 302 may return to the idle state (see 504) in preparation for the next state event or user directed change in environmental conditions.

In yet another embodiment, the detected change of state (step 504) may be a temperature indication generated by the temperature sensor 152 (step 505). The temperature indication may be an analog or digital signal corresponding to the temperature within the patient room 100. For example, the temperature sensor 152 may detect that the temperature within the patient room 100 has increased or decreased and now equals 72° F. In this exemplary embodiment, the detected temperature indication reflects a change in the environmental conditions within the patient room 100 and as such corresponds to a state event. The state event including the detected temperature value (72° F.) may be communicated from the temperature sensor 152 to the HVAC unit 154 along the wired connection 157. The HVAC unit 154 may compare the detected temperature value to a stored threshold value (e.g., a threshold value of 70° F.) and increase the airflow and/or decrease the air temperature within the patient room 100 in an attempt to drive the ambient temperature to the threshold level.

The HVAC unit 154 may communicate the temperature indication, including the detected temperature value (72° F.), to the field panel 158 via the building automation network 160. In due course, the field panel 158 uploads or otherwise communicates the temperature indication to the building automation workstation 162 for further processing. The building automation workstation 162 may identify the temperature indication as a state event and flag it for transmission to the patient room interface 200. Alternatively, the building automation workstation 162 may simply retransmit the temperature indication and the control routine 302 may identify the temperature indication as a state event (step 504). Because the temperature indication represents a sensor update, as opposed to a command that alters the operation of a device associated with the patient room 100, the control routine 302 updates the current state information (step 516) to reflect the detected temperature value (72° F.). The control and user interface 304 can, in turn, update the current temperature value 416 of user interface 400 to reflect the temperature value detected by the sensor 152. The control routine can subsequently return to the idle state to await another change of state (see 504). In operation, the user can manually adjust the temperature threshold, as discussed in connection with the lighting conditions and slider 412, by selecting temperature slider 414 and moving the slider 414a left or right to increase or decrease the temperature within the patient room 100. By selecting the UP temperature button 414b or the DOWN temperature button 414c, the temperature threshold can be incrementally adjusted by degrees (e.g., each increment may correspond to a 1 degree change in the temperature threshold.)

In another embodiment, the control routine 302 may determine that a detected state event (step 504) isn't a sensor update (step 505) and doesn't correspond the lighting routine 306 (see 506), the integrated entertainment routine 308 (see 510), and the HVAC control routine 310 (see 514). In this embodiment, the state event could be an alarm activated on a predetermined date and/or at a predetermined time. In response to the detected state event, the control routine 302 may load or activate the program routine 312 (step 518). The program routine 312 may include predefined activities and commands to alter the patient room environment to a desired configuration. For example, the state event may be a timed alarm selected to prevent the afternoon sun from shining into, and increasing the heat of, the patient room 100. The program routine 312 may identify and utilize the positioning motor 122 and the plurality of shades 120 of the window shade control system 112, the light sensor 114b, and the lights 114 to 118 of the lighting system 110 and the temperature sensor 152 and HVAC unit 154 of the environmental control system 150 to adjust and/or maintain the conditions within the patient room 100 (step 520).

The control routine 302 may, in one embodiment, generate a data packet 318 for each device to be controlled or for each group of devices that communicate according to a common communication protocol (step 522). Alternatively, a single data packet 318 may be generated and utilize an XML envelope 320 that individually identifies the devices and commands to be implemented on those devices. For example, the control routine 302 may generate commands to control the lighting system 110 according to the DALI protocol. Similarly, the control routine 302 can generate commands to control the automation devices operating within the environment control system 150 according to the BACnet protocol.

The generated commands, in turn, can be converted by the SOAP interface 314 to a second protocol (i.e., the XML, platform independent protocol) utilized by the data packet 318 (step 524). The data packet 318, in turn, is communicated to the building automation workstation 162 for decoding via a second SOAP server/interface. Once the commands have been decoded, the building automation workstation 162 can route them to the specific automation devices identified in the headers 322 for execution of the commands contained in the body 324. In operation, commands and information contained in the data packet 318 may cause the positioning motor 122 to close the shades 120 until the ambient light within the patient room 100 reaches a predefined level as measured by the light sensor 114b. The commands and information contained in the data packet 318 may further directed the HVAC unit 154 to increase airflow and decrease the temperature to maintain the temperature within the patient room 100. The operation of the HVAC unit 154 can be controlled in response to temperature indications provided by the temperature sensor 152 in order to minimize the overall energy usage.

In another embodiment, the light sensor 114b may cooperate with both the lights 114 to 118 and the window shade control system 112 to maintain the ambient light within the patient room 100. The user can adjust the ambient light threshold via the user interface 400 and more particularly the AMBIENT LIGHT button 410. By adjusting the lighting and temperature thresholds, the control routine 302 can balance the energy usage of the HVAC unit 154 against the energy usage of the lighting system 110 to maintain the desired light and temperature environmental conditions.

In yet another embodiment, the user interface 400 may be replaced or augmented with one or more alternate user interfaces 600 and 700. These alternate user interfaces 600 and 700 may be accessible via the user interface 400, or they may replace all or parts of the user interface 400. For example, when the user adjusts and moves the lighting slider or control 412, the control routine 302 and the control and user interface routine 304 may, based on the season, time of day, desired energy consumption or other criteria, generate and present the user interface 600 via the display 214. The exemplary user interface 600 provides a means by which the user may control and access the window shade control system 112 to adjust the amount of natural light provided via the window 104.

Upon activation of the user interface 600, the lighting routine 306 portion of the control routine 302 may access and activate a shade control subroutine or other executable code necessary to interface with the window shade control system 112. As previously discussed, this process may begin with the retrieval and loading of the current state information (see step 508) from, for example, the memory 206, the workstation 162, and/or a direct communication request provided to the components of the shade control system 112 (see step 506). The lighting routine 306 may, in turn, provide the loaded information to the control and user interface routine 304 for presentation via the user interface 600.

In one embodiment, the user interface 600 may include a graphical representation 602 of the shades 120. Specifically, the position and angle of the individual shades 120 may be displayed. The user may access and customize these settings via interactive position and angle sliders 604 and 606. For example, by changing the position of the slider 606a, the user can, via the control routine 302, direct the positioning motor 122 to alter the angle or tilt of the individual shades between an open position and a closed position. Altering and adjusting the tilt of each shade, allows the user to increase or decrease the amount of illumination and heat allowed through the window 104. Similarly, the user can raise or lower the entire bank of shades 120 by moving the slider 604a. Specifically, a change in the position of the slider 604a may be detected by the lighting routine 306 portion of the control and user interface routine 304 and quantified by the control routine 302. The quantified position information may, in turn, be transmitted as a data packet 318 to the building automation workstation 162. Depending upon the particular configuration of the system, the information contained within the data packet 318 may be utilized by the building automation workstation 162 to directly control the positioning motor 122 or may be provided to one or more of the field panels 108 and 158 which, in turn, can communicate with and control the operation of the positioning motor 122.

The user interface 700 shown in FIG. 7 illustrates another embodiment and configuration that may be generated and displayed by the control and user interface routine 304 portion of the control routine 302. In this exemplary embodiment, the user interface 700 represents and includes multiple preprogrammed configurations and scenes that may be implemented and customized by the user. The individual scenes and configurations may, in one embodiment, be implemented in conjunction with a comprehensive environmental control system that maintains and optimizes the conditions and systems operable within the structure. By coordinating the operation of the individual scenes and configurations with the control scheme implemented throughout the structure, the conditions and environmental preferences of individual patients are addressed without sacrificing the efficiency and performance of the comprehensive environmental control system.

The scene 702, in this exemplary embodiment, may be selected when the user accesses information, movies and television programs using the integrated entertainment system 130. When the scene 702 is selected through the touchscreen display 214, the control routine 302 may load environmental control parameters such as conditions and thresholds which integrate and coordinate the operation of the room lighting system 110 including the window shade control system 112, the integrated entertainment system 130 and the environmental control system 150. For example, selection of the graphical icon corresponding to the scene 702 may cause an appropriate data packet 318 to be communicated to the building automation workstation 162 and subsequently to the field panels 108 and 158. The data packet 318 may initiate a stored macro or other sequence of environmental control parameters designed to adjust the systems 110, 112, 130 and 150. In one configuration, selection of the scene 702 results in the implementation of a first environmental control parameter that lowers the bank of shades 120 and alters the angle or tilt of the individual shades 120 to block the light from the window 194 from entering the patient room 100. Simultaneously, a second environmental control parameter associated with the scene 702 may cause the individual room lights 114, 116 and 118 to be dimmed to a preconfigured level to make movie or television watching easier for the patient.

In another embodiment, the user may select the scene 704 in order to configure the patient room 100 for sleeping. In this embodiment, selection of the sleep scene 704 causes the control routine 302 and the lighting routing 306 to implement one or more environmental control parameters designed to shut off or substantially reduce the intensity of the lights 114, 116 and 118. Simultaneously, the lighting routine 306, and more particularly the shade control subroutine, may direct the positioning motor 122 of the window shade control system 112 to close the shade bank and increase the shade angle or tilt in order to block ambient light from entering via the window 104.

The user may further associate a temperature setting or threshold with the sleep scene 704 in order to maintain the temperature of the patient room 100 at a desired level. For example, if the user prefers sleeping in a cool room, then selection of the sleep scene 704 may cause the control routine 302, the building automation workstation 162 and one or more of the field panels 108 and 158 to adjust the HVAC unit 154 until the sensor 152 registers the desired temperature. This temperature may further be governed as part of the overall environmental control scheme implemented for the structure. For example, range or degree of adjustment may be limited in order to reduce or control the energy consumption of the structure. In another embodiment, authorized medical personnel may override or further adjust these temperature settings based on the user's diagnosis and/or malady.

Similarly selection of the reading scene 706 and the visitors scene 708 may cause the HVAC unit 154 as well as the systems 110, 112, 130 and 150 of the patient room 100 to reconfigure to the user's programmed specification. For example, when the user identifies the graphical icon corresponding to the reading scene 706 as displayed by the user interface 700, the control routine 302 may direct the lighting routine 306 to reduce the intensity of the overhead light 114 and increase or turn on the patient reading light 116. In other configurations, the control routine 302 may direct the entertainment routine 308 to turn-off or reduce the volume of the television 132. Selection of the graphical icon corresponding to the visitors scene 708, may cause the control routine 302 and the lighting routine 306 to increase the illumination level of the lights 114, 116 and 118.

Alternatively, the control routine 302 and the lighting routine 306 may implement a set of environmental control parameters configured to increase the light level within the patient room 100 by engaging the window shade control system 112 and opening the blinds to increase the natural light. If, in response to this change the window shade control system 112, the light sensor 114b determines that the overall light level is below a preprogrammed threshold; then the control routine 302 and lighting routine 306 may increase the to increase the illumination level of the lights 114, 116 and 118 to compensate. In this way, the conditions requested by the user may be realized while the energy usage of the building may be minimized.

The daylight scene 710 may, in one embodiment, be configured to allow the control routine 302 and the environmental control system of the structure operate in conjunction to maintain and balance the temperature and lighting conditions within the patient room 100 with weather conditions outside the window 104. For example, the user may select the daylight scene 710 and specify a light level to maintain. The control routine 302 may communicate a data packet 318 containing the desired light level to the INSIGHT® application executing on the building automation workstation 162. The INSIGHT® application, in turn, may evaluate the user-defined illumination threshold against the ambient light readings detected via the light sensor 114b. The lighting system 110 and window shade control system 112 may be adjusted relative to each other in order to achieve the desired user-defined threshold. These systems may be further balanced with respect to a user-defined temperature threshold and the temperature detected by the sensor 150. For example, if the user-defined illumination threshold calls for a bright patient room 100, amount of sunlight allowed through the window 104 by the window shade control system 112 may be balanced against the detected increase in ambient temperature. In this way, the environmental control system of the structure can balance the energy requirements of operating the HVAC unit 154 to maintain a temperature against the energy requirements of the lighting system 110 and the illumination allowed and controlled by the window shade control system 112.

The disclosed interface, systems and methods provide a holistic mechanism by which individual patient comfort can be balanced against overall energy efficiency. In operation, the exemplary patient room interface 200, building automation workstation 162 and field panels 108 and 158 utilize seasonal and time of day information in conjunction with a customizable prioritization of resources to control and direct the systems 110, 112, 130 and 150 and/or the HVAC unit 154 within the patient room 100 and the overall structure. The customizable prioritization allows maintenance, controls and/or building operations personnel to define the order in which each system, element and device within the environmental control system are employed in order to maximize patient comfort and building efficiency.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

What is claimed is:

1. A patient room interface comprising:
a processor;
a memory in communication with the processor and configured to store processor-executable instructions to:
detect a state event associated with an environmental condition within the patient room; and
communicate, in response to the detected state event, a data packet containing a payload that includes environmental control information related to a first building automation system and a second building automation system;
independently adjust, in response to the environmental control information, a first environmental control parameter related to the first building automation system and a second environmental control parameter related to the second building automation system;
wherein the second environmental control parameter is different than the first environmental control parameter.

2. The device of claim 1 further comprising:
a communication module in communication with a building automation network, wherein the communication module is configured to wirelessly communicate the data packet.

3. The device of claim 2, wherein the building automation network couples a sensor deployed within the patient room and in communication with the communication module.

4. The device of claim 4, wherein the processor-executable instructions are further configured to:
receive an update to the environmental condition via the sensor.

5. The device of claim 1 further comprising a touchscreen configured to present a graphical user interface, wherein the graphical user interface is configured to receive a user selection corresponding to the state event.

6. The device of claim 1, wherein the building automation systems are selected from the group consisting of: a lighting control system; a window shade control system; an HVAC control system; and an entertainment system.

7. The device of claim 6, wherein the state event corresponds to a scene configured to direct the operation of the lighting control system, the window shade control system, and the HVAC control system in order to achieve a desired condition within the patient room.

8. A patient room environmental control system comprising:
a patient room interface including a processor, and a memory configured to store processor-executable instructions to:
detect a state event representative of an environmental condition within the patient room; and
generate, in response to the state event, a data packet containing a payload, wherein the data packet is formatted according to a first protocol and wherein the payload includes environmental control information;
a building automation controller in communication with the patient room interface via a building automation network, the building automation controller configured to:
receive the data packet formatted according to the first protocol;
generate an environmental control communication according to a second protocol, wherein the environmental control communication includes the environmental control information;
communicate the environmental control communication to an automation device operating according to the second protocol;
adjust the automation device based on the environmental control communication and the environmental control information to change the environmental condition.

9. The system of claim 8, wherein the patient room interface is a bedside control device comprising a touchscreen interface configured to present a user interface.

10. The system of claim 8, wherein the building automation network is a BACnet compatible network.

11. The system of claim 8, wherein the building automation network is a wireless network.

12. The system of claim 8, wherein the building automation workstation is configured to operate as a simple object access protocol server.

13. The system of claim 8, wherein the automation device is selected from the group consisting of: a lighting control device; a window shade positioning device; an HVAC device; and an entertainment device.

14. The system of claim 8, wherein the environmental condition within the patient room is detected by a sensor deployed within the patient room, and wherein the sensor is in communication with the patient room interface via the building automation network.

15. The system of claim 8, wherein the state event is selected from the group consisting of: a timed event, a user selection, a temperature signal, and an ambient light signal.

16. A method of environmental control within a patient room, the method comprising:
detecting a state event representative of an environmental condition within the patient room; and
generating, in response to the state event, a data packet containing a payload, wherein the data packet is formatted according to a first protocol and wherein the payload includes environmental control information;
communicating the data packet to a field panel, wherein the field panel is in communication with a first building automation system and a second building automation system;
adjusting a first environmental control parameter related to the first building automation system based on the environmental control information contained within the received payload; and
adjusting a second environmental control parameter related to the second building automation system based on the environmental control information contained within the received payload, wherein the second environmental control parameter is different than the first environmental control parameter.

17. The method of claim 16, wherein communicating the data packet is accomplished via a wireless communication network.

18. The method of claim 16 further comprising receiving an input from a sensor deployed within the patient room.

19. The method of claim 16 further comprising:
receiving a user input to alter the environmental condition.

20. The method of claim 19, wherein the user input is received via a graphical user interface presented via a touchscreen.

21. The method of claim 16, wherein the data packet is an XML data packet.

22. The method of claim 16, wherein the building automation systems are selected from the group consisting of: a lighting control system; a window shade control system; an HVAC control system; and an entertainment system.

23. A patient room interface comprising:
a processor;
a memory in communication with the processor and configured to store processor-executable instructions to:
receive a state event corresponding to a pre-defined scene, wherein the scene includes a plurality of environmental control parameters associated with a desired environmental condition within the patient room; and
communicate, in response to the received state event, a data packet containing a payload that includes the plurality of environmental control parameters, wherein a first environmental control parameter is associated with a lighting control system and a second environmental control parameter is associated with an HVAC control system;
adjust, based on the plurality of environmental control parameters defined within the scene, the lighting control system based on the first environmental control parameter to achieve a desired lighting condition within the patient room;
adjust, based on the plurality of environmental control parameters defined within the scene, the HVAC control system based on the second environmental control parameter to achieve a desired temperature condition within the patient room;
wherein the desired lighting condition and the desired temperature condition collectively define the desired environmental condition within the patient room.

24. The device of claim 23, wherein the lighting control system comprises window shade control system, and wherein the window shade control system may be adjusted to achieve the desired lighting condition within the patient room.

25. The device of claim 24, wherein the pre-defined scene relates to an entertainment system and wherein the plurality of environmental control parameters adjust the desired lighting condition within the patient room.

26. The device of claim 23 further comprising a touchscreen configured to present a graphical user interface, wherein the graphical user interface is configured to detect the state event corresponding a user selection of the pre-defined scene.
